(19) United States
(12) Patent Application Publication
(10) Pub. No.: US 2026/0274288 A1
(43) Pub. Date: Sep. 17, 2026

(54) AUTONOMOUS VEHICLE UTILIZING A GLOBAL ROAD AND MAP BASED REPRESENTATION OF DRIVING TRAJECTORY DATA

(71) Applicant: Torc Robotics, Inc., Blacksburg, VA (US)

(72) Inventors: Jonas Torzewski, Stuttgart (DE); Maximilian Yassine Beyen, Leutenbach (DE); Marat Kopytjuk, Heilbronn (DE); Lukas Kugler, Stuttgart (DE)

(21) Appl. No.: 19/081,352

(22) Filed: Mar. 17, 2025

(51) Int. Cl. B60W 60/00; B60W 30/18

(52) U.S. Cl. CPC B60W 60/001; B60W 30/18159; B60W 2552/10; B60W 2552/53; B60W 2554/4041; B60W 2556/40

(57) ABSTRACT

An autonomy computing system is provided. The autonomy computing is programmed to retrieve a map including a plurality of ways, each of the plurality of ways representing a road section having a constant number of lanes, retrieve a plurality of predefined associations corresponding to the plurality of ways, each predefined association indicating, for a corresponding way, at least one of a preceding way or a subsequent way, identify, from the map, at least one segment including more than one way of the plurality of ways, the at least one segment having a global origin point, generate a coordinate system for the at least one segment based on the global origin point and the plurality of predefined associations, receive sensor data indicating a presence of at least one object, and determine a global location of the at least one object with respect to the coordinate system.

### TECHNICAL FIELD

The field of the disclosure relates generally to autonomous vehicles and, more specifically, to a global coordinate system for use in controlling autonomous vehicles.

### BACKGROUND OF THE INVENTION

In the fields of autonomous vehicles and autonomous vehicle controllers, the geometry of the road is an important factor in determining the behavior of the different road actors, such as the autonomous vehicle itself and other vehicles on the road. Generally, a coordinate system is used by the autonomous vehicle to characterize the geometry of the road and identify locations of objects on the road. Accordingly, choosing a coordinate system that aligns with the road geometry is advantages for analyzing the most common driving scenarios. However, at least some known coordinate systems fail to cover a relatively large area and/or to account for lanes that are merging in or splitting away. An improved autonomous vehicle controller is therefore desirable.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system for controlling an autonomous vehicle using a global coordinate system is provided. The autonomy computing system includes a processor and a memory in communication with the processor. The processor is programmed to retrieve a map including a plurality of ways, each way of the plurality of ways representing a road section having a constant number of lanes, retrieve a plurality of predefined associations corresponding to the plurality of ways, each predefined association indicating, for a corresponding way of the plurality of ways, at least one of a preceding way or a subsequent way, identify, from the map, at least one segment including more than one way of the plurality of ways, the at least one segment having a global origin point, generate a coordinate system for the at least one segment based on the global origin point and the plurality of predefined associations, receive sensor data indicating a presence of at least one object, determine a global location of the at least one object with respect to the coordinate system, and control operation of the autonomous vehicle based at least in part on the determined global location.

In another aspect, a computer-implemented method for controlling an autonomous vehicle using a global coordinate system is provided. The computer-implemented method is performed by an autonomy computing system a processor and a memory in communication with the processor. The computer-implemented method includes retrieving a map including a plurality of ways, each way of the plurality of ways representing a road section having a constant number of lanes, retrieving a plurality of predefined associations corresponding to the plurality of ways, each predefined association indicating, for a corresponding way of the plurality of ways, at least one of a preceding way or a subsequent way, identifying, from the map, at least one segment including more than one way of the plurality of ways, the at least one segment having a global origin point, generating a coordinate system for the at least one segment based on the global origin point and the plurality of predefined associations, receiving sensor data indicating a presence of at least one object, determining a global location of the at least one object with respect to the coordinate system, and controlling operation of the autonomous vehicle based at least in part on the determined global location.

In another aspect, an autonomous vehicle is provided. The autonomous vehicle includes at least one sensor and an autonomy computing system for controlling the autonomous vehicle. The autonomy computing system includes a processor and a memory in communication with the processor. The processor is configured to retrieve a map including a plurality of ways, each way of the plurality of ways representing a road section having a constant number of lanes, retrieve a plurality of predefined associations corresponding to the plurality of ways, each predefined association indicating, for a corresponding way of the plurality of ways, at least one of a preceding way or a subsequent way, identify, from the map, at least one segment including more than one way of the plurality of ways, the at least one segment having a global origin point, generate a coordinate system for the at least one segment based on the global origin point and the plurality of predefined associations, receive sensor data from the at least one sensor indicating a presence of at least one object, determine a global location of the at least one object with respect to the coordinate system, and control operation of the autonomous vehicle based at least in part on the determined global location.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3A depicts an example section of road network characterized using a plurality of local coordinate systems;

FIG. 3B depicts the example section of road network shown in FIG. 3A characterized using a global coordinate system;

FIG. 4 depicts another example section of road network that can form a looping path;

FIG. 5 depicts another example section or road network having a varying number of lanes;

FIG. 6 is a flowchart illustrating an example method for controlling an autonomous vehicle using a global coordinate system; and

FIG. 7 is a block diagram of an example computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

A Frenet coordinate system is a coordinate system that represents a location with respect to a path, which is some cases, may be a curved path. Frenet coordinate systems are represented using two coordinates, referred to herein as the “s-coordinate” and “t-coordinate.” The s-coordinate represents a length along the curve of the path from a predefined origin point, and the t-coordinate represents a transverse offset from the path. A traverse offset is an offset from the origin point in the direction perpendicular to the curve of the path. A Frenet coordinate system may be used to represent locations with respect to a road. For example, the path may be defined as a line, curved if necessary, running along the center or either edge of a portion of a road designated for one direction of travel. In such cases, the s-coordinate represents a distance along the road from an origin point, and the t-coordinate represents a transverse offset from the defined path. In cases in which the road has multiple lanes for travel in a certain direction, the t-coordinate may be used to determine a lane in which a vehicle or other object is located.

As used herein, the term “way” refers to a real or virtual section of single-direction roadway that has a constant number of lanes and is defined using a local coordinate system (e.g., a Frenet coordinate system) having a local origin point.

As used herein, the term “segment” refers to a real or virtual section of single-direction roadway that includes multiple ways and is defined using a global coordinate system (e.g., a Frenet coordinate system) having a global origin point.

The examples shown herein generally depict road networks having a right-hand drive configuration. However, it should be understood that the embodiments described herein may also be applied in examples in which a road network has a left-hand drive configuration, in which cases certain directional terminology such as “left” or “right” may be exchanged as appropriate.

Autonomous vehicles generally use a digital map for route and path planning. These digital maps generally include a virtual road network that corresponds to an actual road network on which the autonomous vehicle may travel. Typically, this virtual road network is divided into a plurality of sections referred to as ways. Each of these ways has its own local coordinate system (e.g., a Frenet coordinate system). These local coordinate systems may be used by autonomous vehicles for planning and control, for example, by determining current and/or predicting future relative positions of other vehicles or objects on the road. Because each of these local coordinate systems is independent, a technical problem exists in how to efficiently determine a relative position between vehicles or objects that lie within different ways.

The embodiments described herein include an autonomy computing system that facilitates generation of a global coordinate system covering multiple different ways. The group of ways covered by the global coordinate system for a portion of road network that may be referred to as a segment. While the functions described herein are described as being performed by the autonomy computing system, this example is for illustration purposes only, and in alternative embodiments, these functions may be performed by a computing system separate from the autonomy computing system.

In the example embodiment, the autonomy computing system is configured to retrieve a map including a plurality of ways, each way of the plurality of ways representing a road section having a constant number of lanes. The autonomy computing system is further configured to retrieve a plurality of predefined associations corresponding to the plurality of ways. Each of these predefined associations indicate, for a given way of the plurality of ways, at least one of a preceding way (i.e., a way with roadway leading into the given way) or a subsequent way (i.e., a way with roadway leading from the given way). Thus, these predefined associations collectively describe the relative positions of the ways within the road network.

In the example embodiment, the autonomy computing system is further configured to identify, from the map, at least one segment. The segment having more than one way of the plurality of ways, and unlike the individual ways, may include sections of roadway having a varying number of lanes and merging or splitting portions of roadway. The at least one segment has a single global origin point. The autonomy computing system is configured to generate a coordinate system (e.g., a Frenet coordinate system) for the at least one segment based on the global origin point and the plurality of predefined associations. Once the coordinate system is generated, the autonomy computing system can receive sensor data indicating a presence of at least one object and determine a global location of the at least one object with respect to the coordinate system. As described in further detail herein, this type of determination may be used to determine a relative position of other vehicles or objects with respect to an autonomous vehicle for the purposes of planning and controlling operation of the autonomous vehicle.

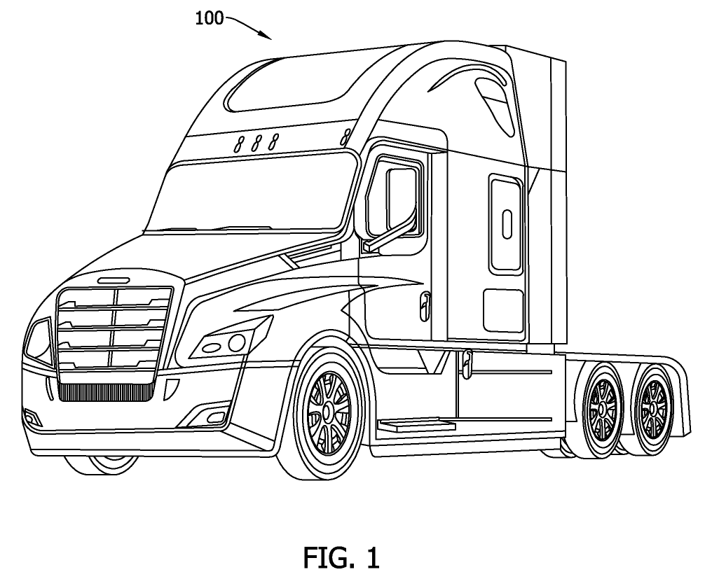

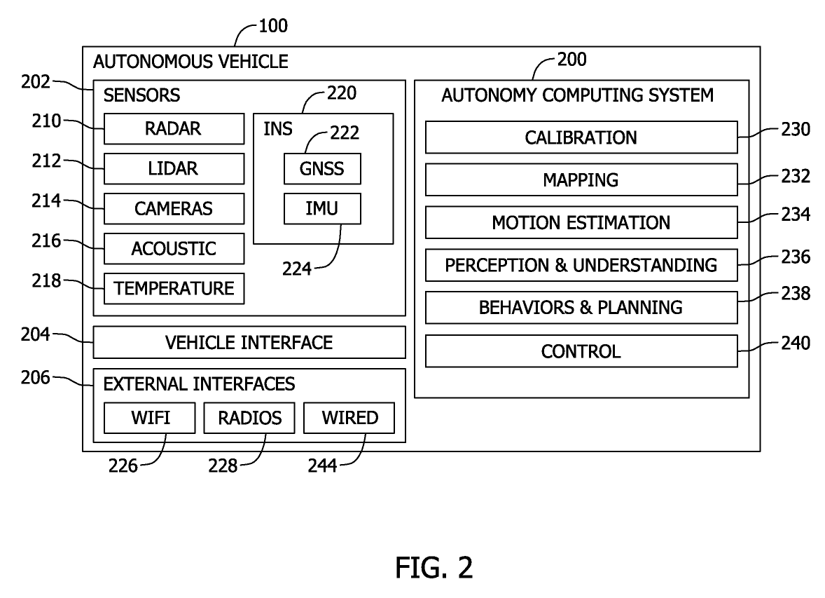

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (radar) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas in front of, to the side of, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be stitched or combined to generate a visual representation of the multiple cameras’ FOVs, which may be used to, for example, generate a bird’s eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas in front of, to the side of, behind, above, or below autonomous vehicle 100 can be captured and represented in the LiDAR point clouds. Radar sensors 210 may include short-range radar (SRR), mid-range radar (MRR), long-range radar (LRR), or ground-penetrating radar (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, and a control module or controller 240. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

In the example embodiment, mapping module 232 is configured to map a location of autonomous vehicle 100 and other objects detected by autonomous vehicle 100 with respect to a digital map. The digital map includes information relating to road geometry, such as locations of roads, widths and/or number of lanes of roads, as well as additional information relating to roads such as road regulations. Specific locations within the digital map are demarcated using one or more coordinate systems.

In the example embodiment, the map includes a plurality of ways, which represent respective road sections of the road network, each of which has a constant number of lanes. For example, an area of road network where a number of lanes changes and/or lanes split or merge together may form a boundary between two ways. Each of the ways is defined by a respective coordinate system and a respective origin point. In some embodiments, the coordinate system is a Frenet coordinate system. Accordingly, any point within the road network can be defined based on local coordinates that describe a location of the point relative to a local origin point (i.e., the origin point corresponding to the way in which the point is located).

A stored plurality of predefined associations indicates how the ways relate to each other. For example, for a given way, the predefined associations may indicate one or more preceding ways (e.g., segments of roadway that are adjacent to and immediately lead to the given way) and/or subsequent ways (e.g., segments or roadway that are adjacent to and lead from the given way). In some situations, a way may have multiple preceding ways (e.g., where two roadways merge together) and/or multiple subsequent ways (e.g., where a roadway splits into multiple parts).

In the example embodiment, mapping module 232 is configured to retrieve the map and the a plurality of predefined associations corresponding to the plurality of ways. From the retrieved map, mapping module 232 is configured to identify at least one segment of the road network. This segment includes more than one way of the plurality of ways and has its own global origin point that is defined separately from the local origin points of the ways that together form the segment. Notably, unlike the individual ways, the segment can cover portions of the road network having different number of lanes and can include portions of roadway that merge into or split off from a main road segment. For example, the segment may represent a length of highway that has a varying number of lanes as well as on-ramps and off-ramps leading to and from the highway.

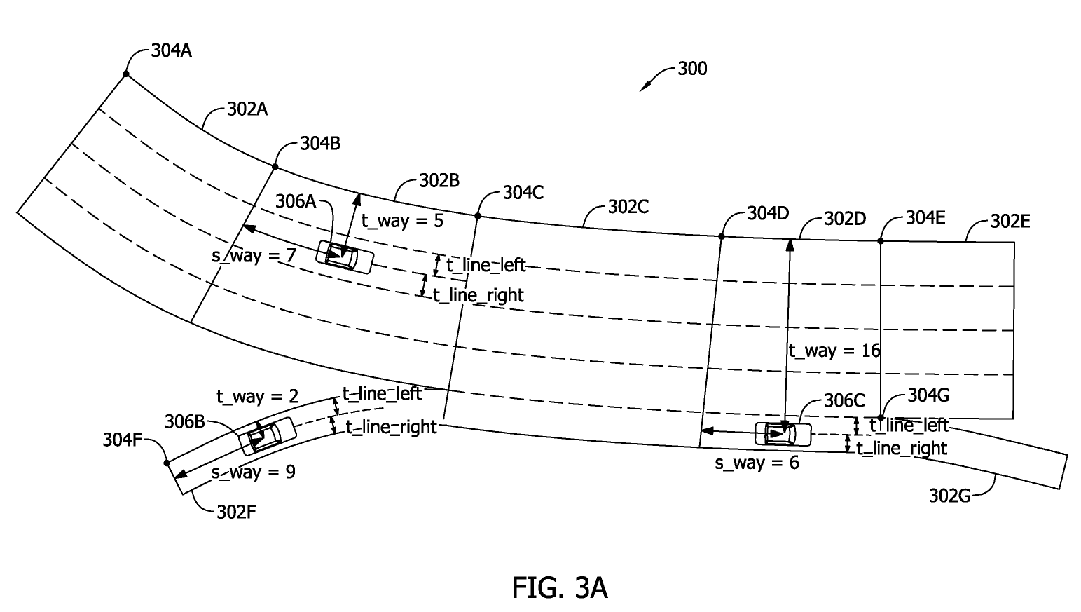

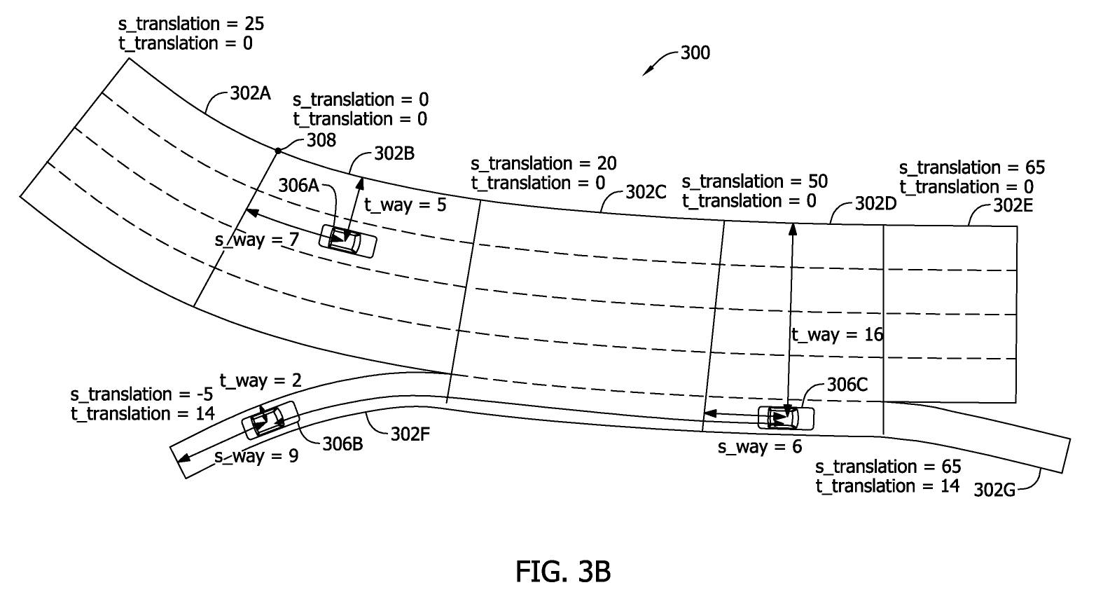

Once the segment is identified, mapping module 232 is configured to generate a global coordinate system for an entirety of the at least one segment based on the global origin point and the plurality of predefined associations. For example, the global coordinate system may be a Frenet coordinate system utilizing the global origin point for the segment as its origin. Accordingly, any point defined by local coordinates corresponding to a local way may also be defined using global coordinates corresponding to the segment. To determine the global coordinates for a particular location, a transformation may be applied to the local coordinates. This transformation in turn may be determined based on a relationship of the way in which the location of interest is located and the global origin point. In some embodiments, mapping module 232 computes this transformation using the local coordinate systems of the way in which the location of interested is located and that of any intervening ways between the location of interest and the global origin point. An example of such as transformation is described in further detail below with respect to FIGS. 3A and 3B.

In the example embodiment, once the global coordinate system for the segment has been defined, perception and understanding module 236 is configured to receive sensor data indicating a presence of at least one object and to determine a global location of the at least one object with respect to the global coordinate system. In some embodiments, perception and understanding module 236 utilizes the global coordinate system when identifying a location of the object, in which case no transformation is necessary. In alternative embodiments, perception and understanding module 236 determines a local location of the object with respect to a local coordinate system, and then performs a transformation to determine the global location of the object. In such embodiments, mapping module 232 and/or perception and understanding module 236 identify a way of the plurality of ways in which the at least one object is located and determine a local location of the at least one object with respect to a local origin point of the identified way. Once the local location is determined, mapping module 232 and/or perception and understanding module 236 perform a transformation on the determined local location based on the global origin point and the plurality of predefined associations to determine the global location.

In certain embodiments, perception and understanding module 236 is further configured to compute a relative position of the autonomous vehicle to the at least one object based on the determined global location of the at least one object with respect to the coordinate system. Generally, computing the relative position based on the global coordinate system is faster and more computationally efficient than computing the relative position based on multiple local coordinate systems because, when multiple local coordinate systems are used, the different local coordinate systems need to be reconciled in real time to compute a single relative position value . In such embodiments, behaviors and planning module 238 and/or control module 240 may plan and control operation of autonomous based at least in part on the computed relative position. For example, behaviors and planning module 238 may plan a path that avoids collision with the object based on the current relative position and expected future relative positions of autonomous vehicle 100 with respect to the object.

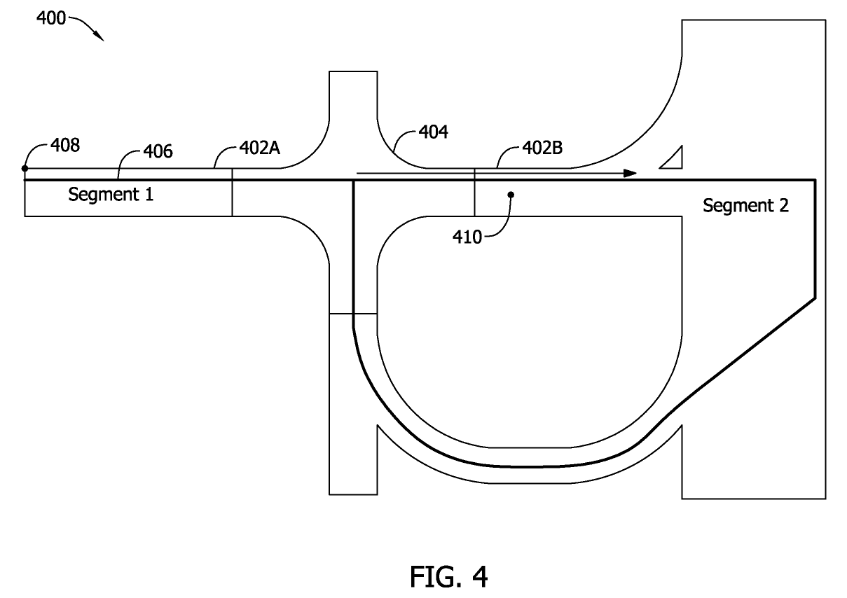

In some situations, a portion of road network that may potentially be identified as a segment may include looping portions of roadway. An example of such a situation is described in further detail below with respect to FIG. 4. When a segment includes a looping portion of roadway, a potentially undesirable result may occur in which multiple different coordinates are assigned to the same location. To avoid such situations, in some embodiments, mapping module 232 is configured to identify a boundary of the at least one segment based on a location of a road intersection. By utilizing intersections as segment boundaries, at least some situations in which a segment includes looping roadway are avoided.

Autonomy computing system 200 of autonomous vehicle 100 may be completely autonomous (fully autonomous), semi-autonomous, or with any level of autonomy. In one example, autonomy computing system 200 may operate under Level 5 autonomy (e.g., full driving automation), Level 4 autonomy (e.g., high driving automation), Level 3 autonomy (e.g., conditional driving automation), Level 2 autonomy (e.g., partial driving automation), or Level 1 autonomy (e.g., driver assistance). As used herein the term “autonomous” includes fully autonomous, semi-autonomous, or having any level of autonomy.

FIGS. 3A and 3B depict an example segment 300, which may form a portion of a road network. Segment 300 includes a plurality of ways 302A-302G. Each of ways 302A-302G is for single-direction travel and has a constant number of lanes. For example, way 302A, way 302B, and way 302E each have four lanes, way 302C and way 302D have five lanes, and way 302F and 302G each have one lane. As described above, one or more predefined associations are stored for each of ways 302A-302G that indicate preceding and subsequent lanes. For example, way 302C has two preceding ways (way 302B and way 302F) and one subsequent way (way 302D), and way 302D has one preceding way (way 302C) and two subsequent ways (way 302D and way 302G).

Referring to FIG. 3A, each of ways 302A-302G has a respective local origin point 304A-304G, based on which a local coordinate system may be defined. For example, in a Frenet coordinate system, the s-coordinate may be defined as a length along a left-side curve of the corresponding way, and the t-coordinate may be defined as a transverse offset from this curve. Three vehicles 306A-306C are shown in FIG. 3A. In some embodiments, one or more of vehicles 306A-306C are similar to autonomous vehicle 100 described above with respect to FIGS. 1 and 2. Vehicle 306A is located within way 302B and has an s-coordinate of 7 and a t-coordinate of 5 within the local coordinate system of way 302B. Vehicle 306B is located within way 302F and has an s-coordinate of 9 and a t-coordinate of 2 within the local coordinate system of way 302F. Vehicle 306C is located within way 304D and has an s-coordinate of 6 and a t-coordinate of 16 within the local coordinate system of way 304D.

Referring to FIG. 3B, segment 300 includes a global origin point 308 that may be used to define a global coordinate system for the entirety of segment 300. For example, in a Frenet coordinate system, the s-coordinate may be defined as a length along a left-side curve of segment 300, and the t-coordinate may be defined as a transverse offset from this curve. As shown in FIG. 3B, each of ways 302A-302F has a respective transformation by which the corresponding local coordinates may be translated to global coordinates.

For example, way 302B has a local origin point 304B that is in the same location as global origin point 308. For this reason, the s-coordinate transformation and the t-coordinate transformation for way 302B are both zero.

Way 302A, way 302C, way 302D, and way 302E each have a respective local origin point that is aligned along the same path (e.g., the left side of segment 300) as global origin point. As a result, the t-coordinate transformation for each of way 302A, way 302C, way 302D, and way 302E is zero, reflecting that there is no transverse offset of these ways from global origin point 308. The s-coordinate transformation for each of way 302A, way 302C, way 302D, and way 302E reflects a distance by which the respective local origin point of these ways leads or follows global origin point 308 along the predefined path. For example, way 302A has an s-coordinate transformation of -25, way 302C has an s-coordinate transformation of 20, way 302D has an s-coordinate transformation of 50, and way 302E has an s-coordinate transformation of 65.

Way 302F and way 302G each have both a transverse and a path-wise offset from global origin point 308. A path-wise offset refers to an offset relative to the origin point along the curve of the path. For example, way 302F has an s-coordinate transformation of -5 and a t-coordinate transformation of 14, and way 302G has an s-coordinate transformation of 65 and a t-coordinate transformation of 14. Note that, while way 302F does not directly precede or follow way 302B, which contains global origin point 308, the s-coordinate transformation for way 302F may be determined by taking the s-coordinate transformation of the following way (i.e., way 302C) and tracing back along the length of the path of way 302F to determine the s-coordinate transformation. For example, because the path of way 302F has a length of 25 and 302F ends at a location having a global s-coordinate of 20, it may be determined that the global s-coordinate of local origin point 304F and the corresponding transformation value is -5.

These transformations may be used to determine locations of vehicles 306A, 306B, and 306C within the global coordinate system. For example, vehicle 306A, which has a local s-coordinate of 7, a local t-coordinate of 5, an s-coordinate transformation of zero, and a t-coordinate transformation of zero based on its location in way 302B, has a global s-coordinate of 7 and a global t-coordinate of 5. Vehicle 306B, which has a local s-coordinate of 9, a local t-coordinate of 2, an s-coordinate transformation of -5, and a t-coordinate transformation of 14 based on its location in way 302F, has a global s-coordinate of 4 and a global t-coordinate of 16. Vehicle 306C, which has a local s-coordinate of 6, a local t-coordinate of 16, an s-coordinate transformation of 50, and a t-coordinate transformation of 0 based on its location in way 302F, has a global s-coordinate of 56 and a global t-coordinate of 16.

Considering all three of vehicles 306A, 306B, and 306C using one global coordinate system simplifies a process of determining a relative position between any two of these three vehicles within the Frenet coordinate system. For example, a relative position of vehicle 306C with respect to vehicle 306A between vehicle 306A and 306C may be determined by computing a difference in corresponding s-coordinates (56 and 7) to determine an s-coordinate differential of 49 and computing a difference in corresponding t-coordinates (16 and 5) to determine a t-coordinate differential of 9.

FIG. 4 depicts an example portion of road network 400 that includes a first segment 402A, a second segment 402B, and an intersection 404. FIG. 4 illustrates a situation in which a looping path 406 may be formed within road network 400. If road network 400 were to be defined as a single segment having a global origin point 408, an ambiguity would be created, in that path 406 passes certain points, such as point 410, multiple times. This would result in multiple different s-coordinate values being assigned to points such as point 410. To avoid this situation, when identifying and defining segments, a boundary of the segments is based on locations of road intersections such as intersection 404. Utilizing intersections as segment boundaries eliminates many situations in which a looping path such as path 406 may be formed within a single segment and create ambiguity within the global coordinate system of the segment as a result. Additionally, or alternatively, to avoid ambiguity, in some cases only the path along which autonomous vehicle 100 travels is considered in determining global s-coordinates and global t-coordinates of objects, while disregarding other path(s) in looping path 406.

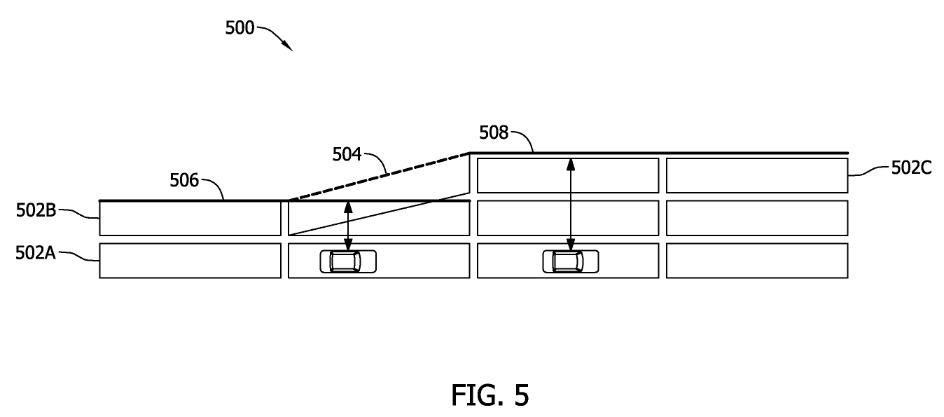

FIG. 5 depicts an example segment 500 that includes a first lane 502A, a second lane 502B, and a third lane 502C. First lane 502A and second lane 502B extend across an entire length of segment 500, and third lane splits from second lane 502B at a split 504. This situation creates a design consideration in generating a global coordinate system, in that if an origin point (e.g., where the t-coordinate equals zero) is defined along the left edge of segment 500 formed by left edge 506 of second lane 502B, split 504, and left edge 508 of third lane 502C, the shift may result in that autonomous vehicle 100 interpreting vehicles travelling directly down first lane 502A or second lane 502B is interpreted as changing lanes. To prevent this situation, when generating a global coordinate system, an entirety of segment 500 should be evaluated and an origin point selected that does not result in a shifting of the origin point with respect to certain lanes. For example, left edge 506 of second lane 502B may be selected as the origin point. In some embodiments, a left edge of the left most continuous lane, e.g., left edge 506, is selected as the origin point. A lane is continuous compared to its neighboring lanes when the angle of the lane has a smaller change than or an equal change to the neighboring lanes.

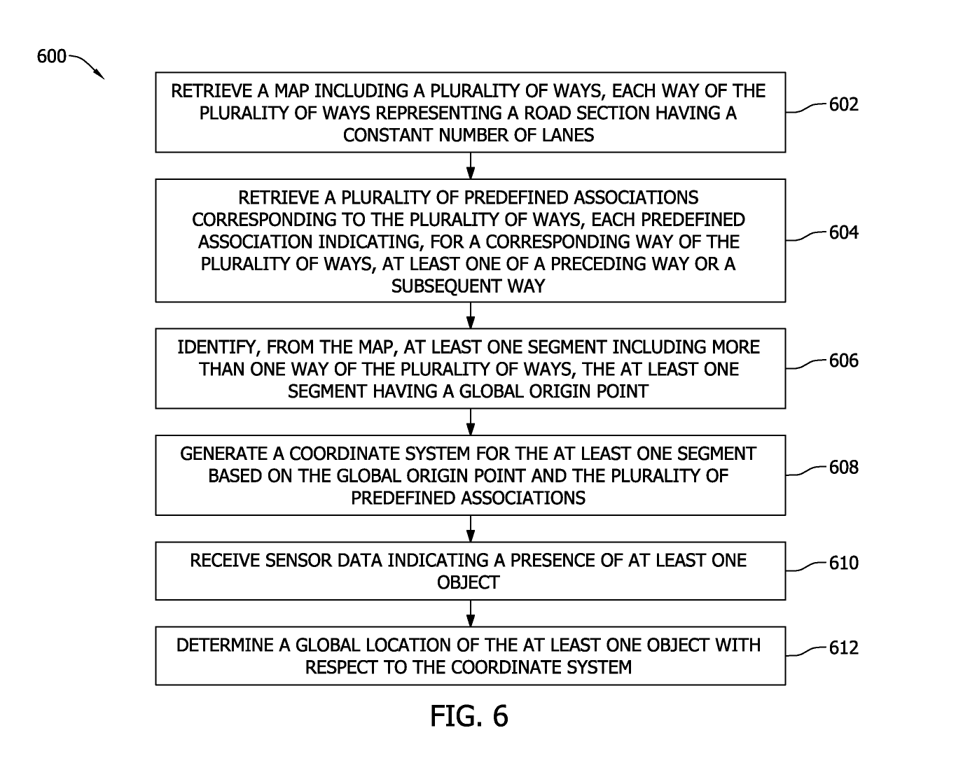

FIG. 6 is a flowchart illustrating an example method 600 for controlling autonomous vehicle 100 using a global coordinate system such as that described with respect to segment 300 shown in FIGS. 3A and 3B. In the example embodiment, method 600 is performed by autonomy computing system 200.

Autonomy computing system 200 retrieves 602 a map including a plurality of ways (such as ways 302A-302G shown in FIGS. 3A and 3B). Each way of the plurality of ways representing a road section having a constant number of lanes. Autonomy computing system retrieves 604 a plurality of predefined associations corresponding to the plurality of ways. Each predefined association indicates, for a corresponding way of the plurality of ways, at least one of a preceding way or a subsequent way. Autonomy computing system identifies 606, from the map, at least one segment (such as segment 300) including more than one way of the plurality of ways, the at least one segment having a global origin point (such as global origin point 308). Autonomy computing system 200 generates 608 a coordinate system for the at least one segment based on the global origin point and the plurality of predefined associations. Autonomy computing system receives 610 sensor data indicating a presence of at least one object (such as vehicles 306A-306C). Autonomy computing system 200 determines 612 a global location of the at least one object with respect to the coordinate system.

In certain embodiments, autonomy computing system 200 identifies a way of the plurality of ways in which the at least one object is located, determines a local location of the at least one object with respect to a local origin point (such as local origin points 304A-304G) of the identified way, and performs a transformation on the determined local location based on the global origin point and the plurality of predefined associations to determine the global location.

In some embodiments, the generated coordinate system is a Frenet coordinate system.

In certain embodiments, each way of the plurality of ways is defined at least in part by a respective local Frenet coordinate system.

In some embodiments, autonomy computing system 200 computes a relative position of autonomous vehicle 100 to the at least one object based on the determined global location of the at least one object with respect to the coordinate system. In some such embodiments, autonomy computing system 200 controls operation of autonomous vehicle 100 based at least in part on the computed relative position.

In certain embodiments, identify a boundary of the at least one segment (such as segments 402A and 402B shown in FIG. 4) based on a location of a road intersection (such as intersection 404).

In some embodiments, the at least one segment includes a road section having a varying number of lanes as shown, for example, in FIGS. 3A, 3B, and 5.

In some embodiments, autonomy computing system 202 generates the coordinate system by identifying a left edge (such as left edge 506) of a left most continuous lane in the at least one segment as the global origin point.

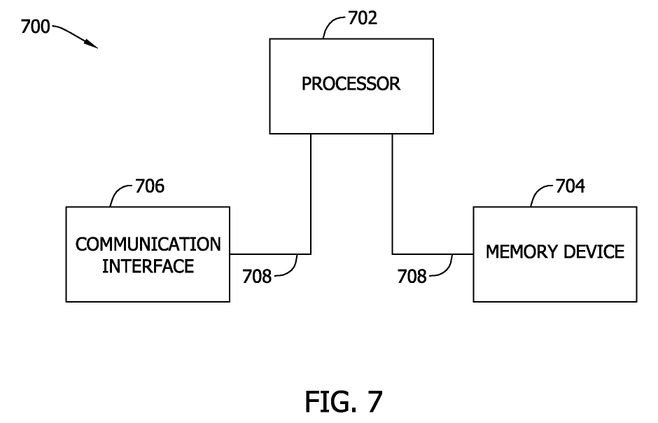

FIG. 7 is a block diagram of an example computing device 700. Computing device 700 includes a processor 702 and a memory device 704. The processor 702 is coupled to the memory device 704 via a system bus 708. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, the memory device 704 includes one or more devices that enable information, such as executable instructions or other data (e.g., sensor data), to be stored and retrieved. Moreover, the memory device 704 includes one or more computer readable media, such as, without limitation, dynamic random access memory (DRAM), static random access memory (SRAM), a solid state disk, or a hard disk. In the example embodiment, the memory device 704 stores, without limitation, application source code, application object code, configuration data, additional input events, application states, assertion statements, validation results, or any other type of data. The computing device 700, in the example embodiment, may also include a communication interface 706 that is coupled to the processor 702 via system bus 708. Moreover, the communication interface 706 is communicatively coupled to data acquisition devices.

In the example embodiment, processor 702 may be programmed by encoding an operation using one or more executable instructions and providing the executable instructions in the memory device 704. In the example embodiment, the processor 702 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

An example technical effect of the methods, systems, and apparatus described herein includes at least one of: (a) reducing computer processing requirements for determining a relative position between an autonomous vehicle and another object on a roadway by generating a global coordinate system covering both a location of the autonomous vehicle and the other object, (b) reducing computer processing requirements for controlling an autonomous vehicle by controlling the autonomous vehicle based on a global coordinate system, and/or (c) improving digital maps by increasing an area of road network that can be characterized using a single global coordinate system.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An autonomy computing system for controlling an autonomous vehicle using a global coordinate system, the autonomy computing system comprising a processor and a memory in communication with the processor, wherein the processor is programmed to:
retrieve a map including a plurality of ways, each way of the plurality of ways representing a road section having a constant number of lanes;
retrieve a plurality of predefined associations corresponding to the plurality of ways, each predefined association indicating, for a corresponding way of the plurality of ways, at least one of a preceding way or a subsequent way;
identify, from the map, at least one segment including more than one way of the plurality of ways, the at least one segment having a global origin point;
generate a coordinate system for the at least one segment based on the global origin point and the plurality of predefined associations;
receive sensor data indicating a presence of at least one object;
determine a global location of the at least one object with respect to the coordinate system; and
control operation of the autonomous vehicle based at least in part on the determined global location.

2. The autonomy computing system of claim 1, wherein the at least one segment includes a road section having a varying number of lanes.

3. The autonomy computing system claim 1, wherein to determine the global location of the at least one object with respect to the coordinate system, the processor is further programmed to:
identify a way of the plurality of ways in which the at least one object is located;
determine a local location of the at least one object with respect to a local origin point of the identified way; and
perform a transformation on the determined local location based on the global origin point and the plurality of predefined associations to determine the global location.

4. The autonomy computing system of claim 1, wherein the coordinate system is a Frenet coordinate system.

5. The autonomy computing system of claim 1, wherein the processor is further programmed to compute a relative position of the autonomous vehicle to the at least one object based on the determined global location of the at least one object with respect to the coordinate system.

6. The autonomy computing system of claim 5, wherein the processor is further programmed to control operation of the autonomous vehicle based at least in part on the computed relative position.

7. The autonomy computing system of claim 1, wherein the processor is further programmed to identify a boundary of the at least one segment based on a location of a road intersection by identifying an intersection in the at least one segment as the boundary.

8. The autonomy computing system of claim 1, wherein the processor is further programmed to generate the coordinate system by identifying a left edge of a left most continuous lane in the at least one segment as the global origin point.

9. A computer-implemented method for controlling an autonomous vehicle using a global coordinate system, the computer-implemented method performed by an autonomy computing system a processor and a memory in communication with the processor, the computer-implemented method comprising:
retrieving a map including a plurality of ways, each way of the plurality of ways representing a road section having a constant number of lanes;
retrieving a plurality of predefined associations corresponding to the plurality of ways, each predefined association indicating, for a corresponding way of the plurality of ways, at least one of a preceding way or a subsequent way;
identifying, from the map, at least one segment including more than one way of the plurality of ways, the at least one segment having a global origin point;
generating a coordinate system for the at least one segment based on the global origin point and the plurality of predefined associations;
receiving sensor data indicating a presence of at least one object;
determining a global location of the at least one object with respect to the coordinate system; and
controlling operation of the autonomous vehicle based at least in part on the determined global location.

10. The computer-implemented method of claim 9, wherein the at least one segment includes a road section having a varying number of lanes.

11. The computer-implemented method of claim 9, wherein determining the global location of the at least one object with respect to the coordinate system comprises:
identifying a way of the plurality of ways in which the at least one object is located;
determining a local location of the at least one object with respect to a local origin point of the identified way; and
performing a transformation on the determined local location based on the global origin point and the plurality of predefined associations to determine the global location.

12. The computer-implemented method of claim 9, wherein the coordinate system is a Frenet coordinate system.

13. The computer-implemented method of claim 9, further comprising computing a relative position of the autonomous vehicle to the at least one object based on the determined global location of the at least one object with respect to the coordinate system.

14. The computer-implemented method of claim 13, further comprising controlling operation of the autonomous vehicle based at least in part on the computed relative position.

15. The computer-implemented method of claim 9, further comprising identifying a boundary of the at least one segment based on a location of a road intersection by identifying an intersection in the at least one segment as the boundary.

16. The computer-implemented method of claim 9, further comprising generating the coordinate system by identifying a left edge of a left most continuous lane in the at least one segment as the global origin point.

17. An autonomous vehicle comprising:
at least one sensor; and
an autonomy computing system for controlling the autonomous vehicle, the autonomy computing system comprising a processor and a memory in communication with the processor, wherein the processor is programmed to:
retrieve a map including a plurality of ways, each way of the plurality of ways representing a road section having a constant number of lanes;
retrieve a plurality of predefined associations corresponding to the plurality of ways, each predefined association indicating, for a corresponding way of the plurality of ways, at least one of a preceding way or a subsequent way;
identify, from the map, at least one segment including more than one way of the plurality of ways, the at least one segment having a global origin point;
generate a coordinate system for the at least one segment based on the global origin point and the plurality of predefined associations;
receive sensor data from the at least one sensor indicating a presence of at least one object;
determine a global location of the at least one object with respect to the coordinate system; and
control operation of the autonomous vehicle based at least in part on the determined global location.

18. The autonomous vehicle of claim 17, wherein the at least one segment includes a road section having a varying number of lanes.

19. The autonomous vehicle of claim 17, wherein to determine the global location of the at least one object with respect to the coordinate system, the processor is further programmed to:
identify a way of the plurality of ways in which the at least one object is located;
determine a local location of the at least one object with respect to a local origin point of the identified way; and
perform a transformation on the determined local location based on the global origin point and the plurality of predefined associations to determine the global location.

20. The autonomous vehicle of claim 17, wherein the processor is further programmed to compute a relative position of the autonomous vehicle to the at least one object based on the determined global location of the at least one object with respect to the coordinate system.
